(19) United States
(12) Patent Application Publication
(10) Pub. No.: US 2020/0160810 A1
(43) Pub. Date: May 21, 2020

(54) IMAGE PROCESSING METHOD AND DISPLAY DEVICE

(71) Applicant: QISDA CORPORATION, Taoyuan City (TW)

(72) Inventor: Guan-Wei Lai, Taoyuan City (TW)

(21) Appl. No.: 16/299,161

(22) Filed: Mar. 12, 2019

(30) Foreign Application Priority Data
Nov. 21, 2018 (CN) 201811390435.6

(51) Int. Cl. G09G 5/02; G09G 5/10

(52) U.S. Cl. CPC G09G 5/02; G09G 2320/0666; G09G 2320/064; G09G 5/10

(57) ABSTRACT

An image processing method includes steps of measuring a plurality of first display characteristics of a display panel under a plurality of input frequencies; determining a plurality of first compensation parameters corresponding to a plurality of first reference input frequencies according to a plurality of first differences between a first target display characteristic and a plurality of first reference display characteristics; using the first compensation parameters to adjust the first display characteristics of the display panel under the input frequencies; after adjusting the first display characteristics, measuring a plurality of second display characteristics of the display panel under the input frequencies; and determining a plurality of second compensation parameters corresponding to a plurality of second reference input frequencies according to a plurality of second differences between a second target display characteristic and a plurality of second reference display characteristics.

### BACKGROUND OF THE INVENTION

### 1. Field of the Invention

The invention relates to an image processing method and a display device and, more particularly, to an image processing method and a display device capable of reducing a color temperature difference and a brightness difference for a display panel under different input frequencies.

### 2. Description of the Prior Art

A display panel is a necessary component for a display device. The display panel is used to display images for a user. Since the bandwidth of a signal source increases, the display panel can support more and more input frequencies accordingly. In general, a color temperature and a brightness of the display panel under different input frequencies may be different, such that a user may feel difference in vision as watching images under different input frequencies. Accordingly, how to reduce a color temperature difference and a brightness difference for the display panel under different input frequencies has become a significant research issue.

### SUMMARY OF THE INVENTION

An objective of the invention is to provide an image processing method and a display device capable of reducing a color temperature difference and a brightness difference for a display panel under different input frequencies, so as to solve the aforesaid problems.

According to an embodiment of the invention, an image processing method comprises steps of measuring a plurality of first display characteristics of a display panel under a plurality of input frequencies, wherein the input frequencies are divided into a first target input frequency and a plurality of first reference input frequencies, and the first display characteristics are divided into a first target display characteristic corresponding to the first target input frequency and a plurality of first reference display characteristics corresponding to the first reference input frequencies; determining a plurality of first compensation parameters corresponding to the first reference input frequencies according to a plurality of first differences between the first target display characteristic and the first reference display characteristics; using the first compensation parameters to adjust the first display characteristics of the display panel under the input frequencies; after adjusting the first display characteristics, measuring a plurality of second display characteristics of the display panel under the input frequencies, wherein the input frequencies are divided into a second target input frequency and a plurality of second reference input frequencies, and the second display characteristics are divided into a second target display characteristic corresponding to the second target input frequency and a plurality of second reference display characteristics corresponding to the second reference input frequencies; and determining a plurality of second compensation parameters corresponding to the second reference input frequencies according to a plurality of second differences between the second target display characteristic and the second reference display characteristics.

In this embodiment, one of the first display characteristic and the second display characteristic is a color temperature and another one of the first display characteristic and the second display characteristic is a brightness.

According to another embodiment of the invention, a display device comprises a display panel, a storage unit and a calculation processing unit, wherein the calculation processing unit is electrically connected to the display panel and the storage unit. The storage unit stores a compensation parameter look-up table, wherein the compensation parameter look-up table records a plurality of input frequencies, a plurality of first compensation parameters corresponding to the input frequencies, and a plurality of second compensation parameters corresponding to the input frequencies. The calculation processing unit receives an image and determines a current input frequency of the image. The calculation processing unit compares the current input frequency with the input frequencies of the compensation parameter look-up table to select a first current compensation parameter corresponding to the current input frequency from the first compensation parameters and select a second current compensation parameter corresponding to the current input frequency from the second compensation parameters. The calculation processing unit uses the first current compensation parameter and the second current compensation parameter to adjust a first display characteristic and a second display characteristic of the display panel.

In this embodiment, one of the first display characteristic and the second display characteristic is a color temperature and another one of the first display characteristic and the second display characteristic is a brightness.

As mentioned in the above, in an embodiment, the invention may determine a plurality of color temperature compensation parameters corresponding to different input frequencies according to a plurality of color temperature differences under different input frequencies first and then determine a plurality of brightness compensation parameters corresponding to different input frequencies according to a plurality of brightness differences under different input frequencies. In another embodiment, the invention may determine a plurality of brightness compensation parameters corresponding to different input frequencies according to a plurality of brightness differences under different input frequencies first and then determine a plurality of color temperature compensation parameters corresponding to different input frequencies according to a plurality of color temperature differences under different input frequencies. Then, the invention can establish a compensation parameter look-up table according to the color temperature compensation parameters and the brightness compensation parameters and store the compensation parameter look-up table in the display device. When the display device receives an image, the display device can select the color temperature compensation parameter and the brightness compensation parameter from the compensation parameter look-up table according to the current input frequency of the image to adjust the color temperature and the brightness of the display panel. Accordingly, the invention can reduce a color temperature difference and a brightness difference for the display panel under different input frequencies, such that the user will not feel obvious difference in vision as watching images under different input frequencies.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a display device according to an embodiment of the invention.

FIG. 2 is a flowchart illustrating an image processing method according to an embodiment of the invention.

FIG. 3 is a flowchart illustrating an image processing method according to another embodiment of the invention.

### DETAILED DESCRIPTION

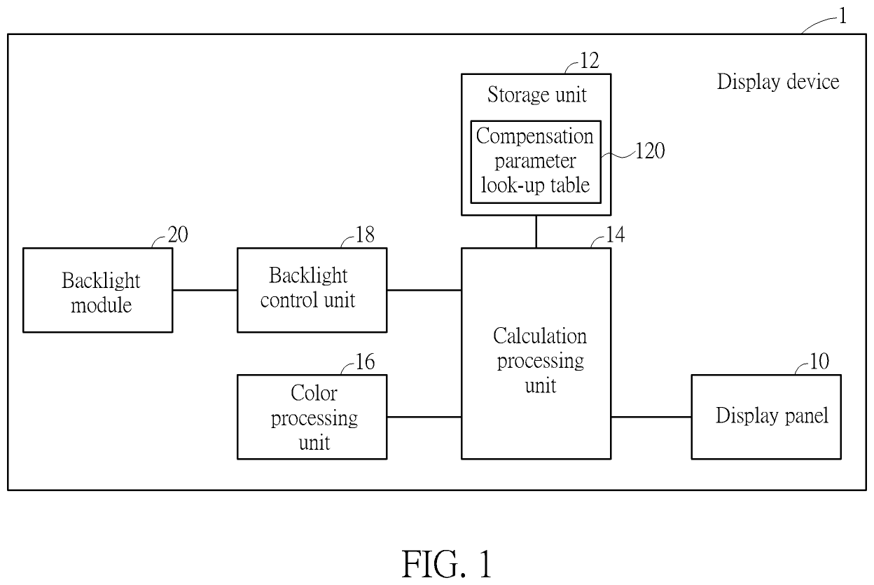

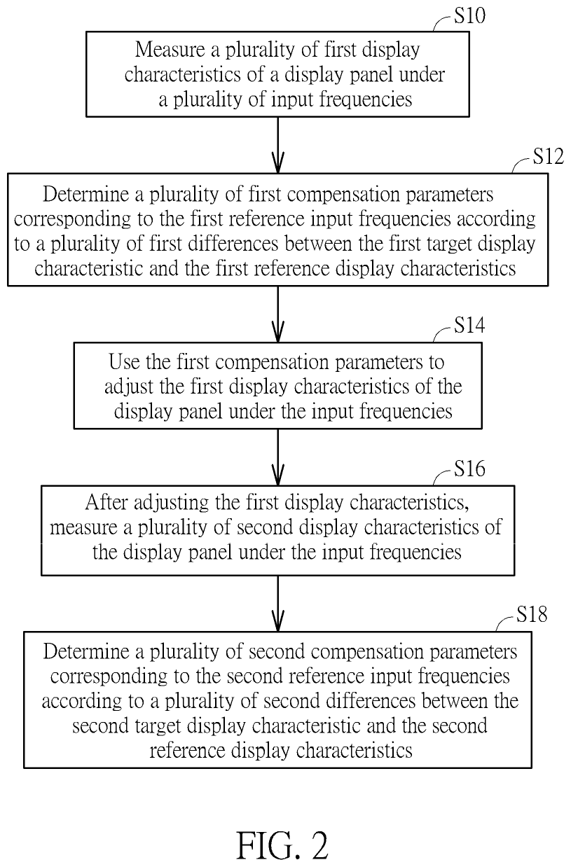

Referring to FIGS. 1 and 2, FIG. 1 is a functional block diagram illustrating a display device 1 according to an embodiment of the invention and FIG. 2 is a flowchart illustrating an image processing method according to an embodiment of the invention.

As shown in FIG. 1, the display device 1 comprises a display panel 10, a storage unit 12, a calculation processing unit 14, a color processing unit 16, a backlight control unit 18 and a backlight module 20, wherein the calculation processing unit is electrically connected to the display panel 10, the storage unit 12, the color processing unit 16 and the backlight control unit 18, and the backlight control unit 18 is electrically connected to the backlight module 20. In this embodiment, the display panel 10 may be a liquid crystal display panel or other display panels; the storage unit 12 may be a memory or other data storage devices; the calculation processing unit 14 may be a processor or a controller with signal processing/calculating function; and the color processing unit 16 may be a color engine in a scalar or other color processors. Furthermore, the color processing unit 16 is used to adjust a color temperature of the display panel 10 and the backlight control unit 18 is used to control a driving current of the backlight module 20 to adjust a brightness of the display panel 10. In general, the display device 1 may be further equipped with some necessary hardware or software components for specific purposes, such as an input/output port, applications, a circuit board, a power supply, a communication module, etc., and it depends on practical applications.

The storage unit 12 stores a compensation parameter look-up table 120, wherein the compensation parameter look-up table 120 may be established by the image processing method shown in FIG. 2. First, an operator may use a measuring instrument to measure a plurality of first display characteristics of the display panel 10 under a plurality of input frequencies (step S10 in FIG. 2). In this embodiment, the input frequencies may be between 30 Hz and 240 Hz and the first display characteristic may be a color temperature, as shown in Table 1 below. When the first display characteristic is the color temperature, the aforesaid measuring instrument may be a color temperature meter. Furthermore, the input frequencies may be divided into a first target input frequency (e.g. 240 Hz) and a plurality of first reference input frequencies (e.g. 30 Hz to 230 Hz), and the first display characteristics may be divided into a first target display characteristic corresponding to the first target input frequency and a plurality of first reference display characteristics corresponding to the first reference input frequencies.

TABLE 1

| | | First display characteristic | | | | First |
|---|---|---|---|---|---|---|
| | | (color temperature) | | | | compensation |
| Input | | | Color | | | parameter |
| frequency | | | coordinate | | First | (RGB gain |
| (Hz) | | | x | y | difference | value) |
| First | 30 | First | 0.311 | 0.329 | X: +0.004 | R gain value: |
| reference | | reference | | | Y: +0.004 | 0.969 |
| input | | display | | | | G gain value: |
| frequency | | characteristic | | | | 0.969 |
| | | | | | | B gain value: |
| | | | | | | 1 |
| | 40 | | . . . | . . . | . . . | . . . |
| | 50 | | . . . | . . . | . . . | . . . |
| | 60 | | 0.31 | 0.328 | X: +0.003 | R gain value: |
| | | | | | Y: +0.003 | 0.977 |
| | | | | | | G gain value: |
| | | | | | | 0.977 |
| | | | | | | B gain value: |
| | | | | | | 1 |
| | 70 | | . . . | . . . | . . . | . . . |
| | 80 | | . . . | . . . | . . . | . . . |
| | 90 | | . . . | . . . | . . . | . . . |
| | 100 | | . . . | . . . | . . . | . . . |
| | 110 | | . . . | . . . | . . . | . . . |
| | 120 | | 0.31 | 0.327 | X: +0.003 | R gain value: |
| | | | | | Y: +0.002 | 0.977 |
| | | | | | | G gain value: |
| | | | | | | 0.984 |
| | | | | | | B gain value: |
| | | | | | | 1 |
| | . . . | | . . . | . . . | . . . | . . . |
| | 230 | | . . . | . . . | . . . | . . . |
| First | 240 | First target | 0.307 | 0.325 | N/A | N/A |
| target | | display | | | | |
| input | | characteristic | | | | |
| frequency | | | | | | |

In Table 1, since the first display characteristic is the color temperature, the first display characteristic may be represented by a color coordinate (x, y). Furthermore, the first target display characteristic may be a native color temperature of the display panel 10. In other words, the invention may take an input frequency corresponding to the native color temperature of the display panel 10 to be the first target input frequency and take other input frequencies to be the first reference input frequencies. At this time, the first display characteristics corresponding to the first reference input frequencies are the first reference display characteristics. Needless to say, the first target input frequency and the first target display characteristic may also be other input frequencies and other first display characteristics according to practical applications.

Then, a processing device (e.g. computer) determines a plurality of first compensation parameters corresponding to the first reference input frequencies according to a plurality of first differences between the first target display characteristic and the first reference display characteristics (step S12 in FIG. 2). As shown in Table 1, the processing device may compare the first target display characteristic with each of the first reference display characteristics to obtain the first differences. Then, the calculation processing unit 14 may adjust RGB gain values for each of the first reference input frequencies continuously to make the first differences approximate or be equal to 0, so as to the RGB gain values (i.e. the first compensation parameters) corresponding to each of the first reference input frequencies. In another embodiment, the first compensation parameter may also be implemented by a color correction matrix or a combination of RGB gain value and color correction matrix. The method of generating the color correction matrix corresponding to each of the first reference input frequencies is identical to the method of generating the RGB gain value, so it will not be depicted herein again.

Then, the calculation processing unit 14 uses the first compensation parameters to adjust the first display characteristics of the display panel 10 under the input frequencies (step S14 in FIG. 2). Taking the input frequency 30 Hz for example, the calculation processing unit 14 uses the first compensation parameter including R gain value (0.969), B gain value (0.969) and B gain value (1) in Table 1 to control the color processing unit 16 to adjust the first display characteristic (color temperature) of the display panel 10, so as to make the first display characteristic (color temperature) under the input frequency 30 Hz approximate or be equal to the first target display characteristic (color temperature) under the first target input frequency 240 Hz. The method of adjusting the first display characteristic under other input frequencies is identical to the aforesaid method, so it will not be depicted herein again.

After adjusting the first display characteristics, the operator may use another measuring instrument to measure a plurality of second display characteristics of the display panel 10 under the input frequencies (step S16 in FIG. 2). In this embodiment, the second display characteristic maybe a brightness, as shown in Table 2 below. When the second display characteristic is the brightness, the aforesaid measuring instrument maybe a brightness meter. Furthermore, the input frequencies may be divided into a second target input frequency (e.g. 240 Hz) and a plurality of second reference input frequencies (e.g. 30 Hz to 230 Hz), and the second display characteristics may be divided into a second target display characteristic corresponding to the second target input frequency and a plurality of second reference display characteristics corresponding to the second reference input frequencies.

TABLE 2

| | | | | | Second |
|---|---|---|---|---|---|
| | | | | | compensation |
| | | | | | parameter |
| | | | | | (driving |
| | | Second display | | | current |
| Input frequency | | characteristic | | Second | adjusting |
| (Hz) | | (brightness: lux) | | difference | value: mA) |
| Second | 30 | Second | 335.4 | +5.4 | −7 |
| reference | 40 | reference | . . . | . . . | . . . |
| input | 50 | display | . . . | . . . | . . . |
| frequency | 60 | characteristic | 334.1 | +4.1 | −6 |
| | 70 | | . . . | . . . | . . . |
| | 80 | | . . . | . . . | . . . |
| | 90 | | . . . | . . . | . . . |
| | 100 | | . . . | . . . | . . . |
| | 110 | | . . . | . . . | . . . |
| | 120 | | 332.1 | +2.1 | −3 |
| | . . . | | . . . | . . . | . . . |
| | 230 | | . . . | . . . | . . . |
| Second | 240 | Second target | 330 | N/A | N/A |
| target | | display | | | |
| input | | characteristic | | | |
| frequency | | | | | |

As shown in Table 2, when the second display characteristics are a plurality of brightness, the second target display characteristic may be a minimum brightness of the plurality of brightness. In other words, the invention may take an input frequency corresponding to the minimum brightness to be the second target input frequency and take other input frequencies to be the second reference input frequencies. At this time, the second display characteristics corresponding to the second reference input frequencies are the second reference display characteristics. Needless to say, the second target input frequency and the second target display characteristic may also be other input frequencies and other second display characteristics according to practical applications.

In practical applications, the brightness of the display panel 10 is controlled by the brightness of the backlight module 20 and the brightness of the backlight module 20 is controlled by the driving current of the backlight module 20. If the driving current has been 100% and cannot be increased anymore, the brightness of the display panel 10 cannot be increased accordingly. Thus, taking the minimum brightness to be the second target display characteristic can avoid the aforesaid situation. It should be noted that if each of the second display characteristics in Table 2 can be increased or decreased arbitrarily, the second target display characteristic maybe any one of the second display characteristics.

Then, the processing device (e.g. computer) determines a plurality of second compensation parameters corresponding to the second reference input frequencies according to a plurality of second differences between the second target display characteristic and the second reference display characteristics (step S18 in FIG. 2). As shown in Table 2, the processing device may compare the second target display characteristic with each of the second reference display characteristics to obtain the second differences. Then, the calculation processing unit 14 may adjust the driving current for each of the second reference input frequencies continuously to make the second differences approximate or be equal to 0, so as to the driving current adjusting values (i.e. the second compensation parameters) corresponding to each of the second reference input frequencies.

Then, the invention may generate the compensation parameter look-up table 120 according to Table 1 and Table 2, wherein the compensation parameter look-up table 120 records a plurality of input frequencies, a plurality of first compensation parameters corresponding to the input frequencies, and a plurality of second compensation parameters corresponding to the input frequencies, as shown in Table 3 below.

TABLE 3
Compensation parameter look-up table 120

| | | Second compensation |
|---|---|---|
| | First compensation | parameter |
| | parameter | (driving current |
| Input frequency | (RGB gain value) | adjusting value: mA) |
| 30 | R gain value: 0.969 | −7 |
| | G gain value: 0.969 | |
| | B gain value: 1 | |
| 40 | . . . | . . . |
| 50 | . . . | . . . |
| 60 | R gain value: 0.977 | −6 |
| | G gain value: 0.977 | |
| | B gain value: 1 | |
| 70 | . . . | . . . |
| 80 | . . . | . . . |
| 90 | . . . | . . . |
| 100 | . . . | . . . |
| 110 | . . . | . . . |
| 120 | R gain value: 0.977 | −3 |
| | G gain value: 0.984 | |
| | B gain value: 1 | |
| . . . | . . . | . . . |
| 230 | . . . | . . . |
| 240 | N/A | N/A |

In another embodiment, the aforesaid first display characteristic may also be the brightness and the aforesaid second display characteristic may also be the color temperature. At this time, the steps S10-S12 of the image processing method shown in FIG. 2 may be performed to obtain Table 4 below.

TABLE 4

| | | | | | First |
|---|---|---|---|---|---|
| | | | | | compensation |
| | | | | | parameter |
| | | | | | (driving |
| | | First display | | | current |
| Input frequency | | characteristic | | First | adjusting |
| (Hz) | | (brightness: lux) | | difference | value: mA) |
| First | 30 | First | 336.1 | +6.1 | −8 |
| reference | 40 | reference | . . . | . . . | . . . |
| input | 50 | display | . . . | . . . | . . . |
| frequency | 60 | characteristic | 335.2 | +5.2 | −7 |
| | 70 | | . . . | . . . | . . . |
| | 80 | | . . . | . . . | . . . |
| | 90 | | . . . | . . . | . . . |
| | 100 | | . . . | . . . | . . . |
| | 110 | | . . . | . . . | . . . |
| | 120 | | 333.2 | +3.2 | −4 |
| | . . . | | . . . | . . . | . . . |
| | 230 | | . . . | . . . | . . . |
| First | 240 | First target | 330 | N/A | N/A |
| target | | display | | | |
| input | | characteristic | | | |
| frequency | | | | | |

As shown in Table 4, when the first display characteristics are a plurality of brightness, the first target display characteristic may be a minimum brightness of the plurality of brightness. In other words, the invention may take an input frequency corresponding to the minimum brightness to be the first target input frequency and take other input frequencies to be the first reference input frequencies. At this time, the first display characteristics corresponding to the first reference input frequencies are the first reference display characteristics. Needless to say, the first target input frequency and the first target display characteristic may also be other input frequencies and other first display characteristics according to practical applications.

Then, in the step S14 in FIG. 2, taking the input frequency 30 Hz for example, the calculation processing unit 14 uses the first compensation parameter, i.e. the driving current adjusting value −8 mA in Table 4, to control the backlight control unit 18 to adjust the driving current of the backlight module 20 to adjust the first display characteristic (brightness) of the display panel 10, so as to make the first display characteristic (brightness) under the input frequency 30 Hz approximate or be equal to the first target display characteristic (brightness) under the first target input frequency 240 Hz. The method of adjusting the first display characteristic under other input frequencies is identical to the aforesaid method, so it will not be depicted herein again.

TABLE 5

| | | Second display characteristic | | | | Second |
|---|---|---|---|---|---|---|
| | | (color temperature) | | | | compensation |
| Input | | | Color | | | parameter |
| frequency | | | coordinate | | Second | (RGB gain |
| (Hz) | | | x | y | difference | value) |
| Second | 30 | Second | 0.311 | 0.329 | X: +0.004 | R gain value: |
| reference | | reference | | | Y: +0.004 | 0.969 |
| input | | display | | | | G gain value: |
| frequency | | characteristic | | | | 0.969 |
| | | | | | | B gain value: |
| | | | | | | 1 |
| | 40 | | . . . | . . . | . . . | . . . |
| | 50 | | . . . | . . . | . . . | . . . |
| | 60 | | 0.31 | 0.328 | X: +0.003 | R gain value: |
| | | | | | Y: +0.003 | 0.977 |
| | | | | | | G gain value: |
| | | | | | | 0.977 |
| | | | | | | B gain value: |
| | | | | | | 1 |
| | 70 | | . . . | . . . | . . . | . . . |
| | 80 | | . . . | . . . | . . . | . . . |
| | 90 | | . . . | . . . | . . . | . . . |
| | 100 | | . . . | . . . | . . . | . . . |
| | 110 | | . . . | . . . | . . . | . . . |
| | 120 | | 0.31 | 0.327 | X: +0.003 | R gain value: |
| | | | | | Y: +0.002 | 0.977 |
| | | | | | | G gain value: |
| | | | | | | 0.984 |
| | | | | | | B gain value: |
| | | | | | | 1 |
| | . . . | | . . . | . . . | . . . | . . . |
| | 230 | | . . . | . . . | . . . | . . . |
| Second | 240 | Second target | 0.307 | 0.325 | N/A | N/A |
| target | | display | | | | |
| input | | characteristic | | | | |
| frequency | | | | | | |

In Table 5, since the second display characteristic is the color temperature, the second display characteristic may be represented by a color coordinate (x, y). Furthermore, the second target display characteristic may be a native color temperature of the display panel 10. In other words, the invention may take an input frequency corresponding to the native color temperature of the display panel 10 to be the second target input frequency and take other input frequencies to be the second reference input frequencies. At this time, the second display characteristics corresponding to the second reference input frequencies are the second reference display characteristics. Needless to say, the second target input frequency and the second target display characteristic may also be other input frequencies and other second display characteristics according to practical applications. Moreover, in another embodiment, the second compensation parameter may also be implemented by a color correction matrix or a combination of RGB gain value and color correction matrix. The method of generating the color correction matrix corresponding to each of the second reference input frequencies is identical to the method of generating the RGB gain value, so it will not be depicted herein again.

Then, the invention may generate the compensation parameter look-up table 120 according to Table 4 and Table 5, wherein the compensation parameter look-up table 120 records a plurality of input frequencies, a plurality of first compensation parameters corresponding to the input frequencies, and a plurality of second compensation parameters corresponding to the input frequencies, as shown in Table 6 below.

TABLE 6
Compensation parameter look-up table 120

| | First compensation | |
|---|---|---|
| | parameter | Second compensation |
| | (driving current | parameter |
| Input frequency | adjusting value: mA) | (RGB gain value) |
| 30 | −8 | R gain value: 0.969 |
| | | G gain value: 0.969 |
| | | B gain value: 1 |
| 40 | . . . | . . . |
| 50 | . . . | . . . |
| 60 | −7 | R gain value: 0.977 |
| | | G gain value: 0.977 |
| | | B gain value: 1 |
| 70 | . . . | . . . |
| 80 | . . . | . . . |
| 90 | . . . | . . . |
| 100 | . . . | . . . |
| 110 | . . . | . . . |
| 120 | −4 | R gain value: 0.977 |
| | | G gain value: 0.984 |
| | | B gain value: 1 |
| . . . | . . . | . . . |
| 230 | . . . | . . . |
| 240 | N/A | N/A |

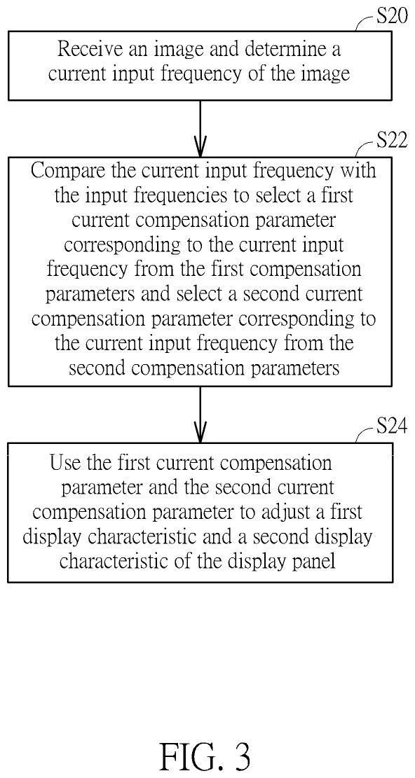

Referring to FIG. 3, FIG. 3 is a flowchart illustrating an image processing method according to another embodiment of the invention. The image processing method shown in FIG. 3 is adapted to the display device 1 shown in FIG. 1.

After generating the compensation parameter look-up table 120 of the display panel 10, the invention may store the compensation parameter look-up table 120 in the storage unit 12 of the display device 1. When the display device 1 is used to display an image, the calculation processing unit 14 receives the image and determines a current input frequency of the image (step S20 in FIG. 3). Then, the calculation processing unit 14 compares the current input frequency with the input frequencies in the compensation parameter look-up table 120 to select a first current compensation parameter corresponding to the current input frequency from the first compensation parameters and select a second current compensation parameter corresponding to the current input frequency from the second compensation parameters (step S22 in FIG. 3). Then, the calculation processing unit 14 uses the first current compensation parameter and the second current compensation parameter to adjust a first display characteristic and a second display characteristic of the display panel 10 (step S24 in FIG. 3).

When the first display characteristic is a color temperature and the second display characteristic is a brightness, the compensation parameter look-up table 120 is represented by Table 3 given above. If the current input frequency is 120 Hz, the first current compensation parameter includes R gain value (0.977), G gain value (0.984) and B gain value (1) , and the second current compensation parameter is the driving current adjusting value −3 mA. Accordingly, the calculation processing unit 14 uses R gain value (0.977), G gain value (0.984) and B gain value (1) to control the color processing unit 16 to adjust the first display characteristic (color temperature) of the display panel 10, and the calculation processing unit 14 controls the backlight control unit 18 to adjust a predetermined driving current of the backlight module 20 by the driving current adjusting value −3 mA to adjust the second display characteristic (brightness) of the display panel 10.

When the first display characteristic is a brightness and the second display characteristic is a color temperature, the compensation parameter look-up table 120 is represented by Table 6 given above. If the current input frequency is 60 Hz, the first current compensation parameter is the driving current adjusting value −7 mA, and the second current compensation parameter includes R gain value (0.977), G gain value (0.977) and B gain value (1). Accordingly, the calculation processing unit 14 controls the backlight control unit 18 to adjust a predetermined driving current of the backlight module 20 by the driving current adjusting value −7 mA to adjust the first display characteristic (brightness) of the display panel 10, and the calculation processing unit 14 uses R gain value (0.977), G gain value (0.977) and B gain value (1) to control the color processing unit 16 to adjust the second display characteristic (color temperature) of the display panel 10.

As mentioned in the above, in an embodiment, the invention may determine a plurality of color temperature compensation parameters corresponding to different input frequencies according to a plurality of color temperature differences under different input frequencies first and then determine a plurality of brightness compensation parameters corresponding to different input frequencies according to a plurality of brightness differences under different input frequencies. In another embodiment, the invention may determine a plurality of brightness compensation parameters corresponding to different input frequencies according to a plurality of brightness differences under different input frequencies first and then determine a plurality of color temperature compensation parameters corresponding to different input frequencies according to a plurality of color temperature differences under different input frequencies. Then, the invention can establish a compensation parameter look-up table according to the color temperature compensation parameters and the brightness compensation parameters and store the compensation parameter look-up table in the display device. When the display device receives an image, the display device can select the color temperature compensation parameter and the brightness compensation parameter from the compensation parameter look-up table according to the current input frequency of the image to adjust the color temperature and the brightness of the display panel. Accordingly, the invention can reduce a color temperature difference and a brightness difference for the display panel under different input frequencies, such that the user will not feel obvious difference in vision as watching images under different input frequencies.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method comprising steps of:
measuring a plurality of first display characteristics of a display panel under a plurality of input frequencies, wherein the input frequencies are divided into a first target input frequency and a plurality of first reference input frequencies, and the first display characteristics are divided into a first target display characteristic corresponding to the first target input frequency and a plurality of first reference display characteristics corresponding to the first reference input frequencies;
determining a plurality of first compensation parameters corresponding to the first reference input frequencies according to a plurality of first differences between the first target display characteristic and the first reference display characteristics;
using the first compensation parameters to adjust the first display characteristics of the display panel under the input frequencies;
after adjusting the first display characteristics, measuring a plurality of second display characteristics of the display panel under the input frequencies, wherein the input frequencies are divided into a second target input frequency and a plurality of second reference input frequencies, and the second display characteristics are divided into a second target display characteristic corresponding to the second target input frequency and a plurality of second reference display characteristics corresponding to the second reference input frequencies; and
determining a plurality of second compensation parameters corresponding to the second reference input frequencies according to a plurality of second differences between the second target display characteristic and the second reference display characteristics.

2. The image processing method of claim 1, wherein one of the first display characteristic and the second display characteristic is a color temperature and another one of the first display characteristic and the second display characteristic is a brightness.

3. The image processing method of claim 1, further comprising steps of:
receiving an image and determining a current input frequency of the image;
comparing the current input frequency with the input frequencies to select a first current compensation parameter corresponding to the current input frequency from the first compensation parameters and select a second current compensation parameter corresponding to the current input frequency from the second compensation parameters; and
using the first current compensation parameter and the second current compensation parameter to adjust the first display characteristic and the second display characteristic of the display panel.

4. The image processing method of claim 1, wherein one of the first target display characteristic and the second target display characteristic is a native color temperature of the display panel.

5. The image processing method of claim 1, wherein when the first display characteristics are a plurality of brightness, the first target display characteristic is a minimum brightness of the plurality of brightness; when the second display characteristics are a plurality of brightness, the second target display characteristic is a minimum brightness of the plurality of brightness.

6. A display device comprising:
a display panel;
a storage unit storing a compensation parameter look-up table, the compensation parameter look-up table recording a plurality of input frequencies, a plurality of first compensation parameters corresponding to the input frequencies, and a plurality of second compensation parameters corresponding to the input frequencies; and
a calculation processing unit electrically connected to the display panel and the storage unit;
wherein the calculation processing unit receives an image and determines a current input frequency of the image; the calculation processing unit compares the current input frequency with the input frequencies of the compensation parameter look-up table to select a first current compensation parameter corresponding to the current input frequency from the first compensation parameters and select a second current compensation parameter corresponding to the current input frequency from the second compensation parameters; the calculation processing unit uses the first current compensation parameter and the second current compensation parameter to adjust a first display characteristic and a second display characteristic of the display panel.

7. The display device of claim 6, wherein one of the first display characteristic and the second display characteristic is a color temperature and another one of the first display characteristic and the second display characteristic is a brightness.
